(19) United States
(12) Patent Application Publication
(10) Pub. No.: US 2010/0252168 A1
(43) Pub. Date: Oct. 7, 2010

(54) BACKED PILE WEATHERSTRIP

(76) Inventors: Ian Pawson, Cambs (GB); Mark D. Foster, Pittsford, NY (US); Vincent Outters, Bellem (BE); Thomas M. Sesock, Pittsford, NY (US)

Correspondence Address: BARNES & THORNBURG LLP, P.O. BOX 2786, CHICAGO, IL, 60690-2786, US

(21) Appl. No.: 11/718,850

(22) PCT Filed: Nov. 8, 2005
(86) PCT No.: PCT/US2005/040390

§ 371 Date: Jun. 18, 2010

(30) Foreign Application Priority Data
Nov. 8, 2004 (GB) 0424547.8

(51) Int. Cl. E06B 7/22; B29C 47/02; E06B 7/16

(52) U.S. Cl. 156/72; 156/380.9; 156/500; 49/475.1

(57) ABSTRACT

A new method of making and manufacturing pile weather stripping is described using a non-woven, e.g. a knitted pile that is either cropped or slit to the correct pile height. The pile is then precisely introduced to a singer using guides. After the singing process the knitted pile is guided into the extruder head where the base is extruded around the knitted pile. The density of the knitted pile weather stripping is controlled by adding or removing filling yarns, picks and changing of the yarn denier. The base thickness and configuration is a direct function of the extrusion head. A pile fin or fins can be added as a purchased raw good or extruded as part of the process. The inventive pile weather stripping allows for the fabrication of any pile height, pile density and backing configuration to include throat width, T-slot width, T-slot base depth and varying fin heights. The method can be used to make a weather stripping comprising pile extending from a backing, the pile comprising pile yarns, the backing being bonded to the pile, a synthetic fibre being interlaced with the pile yarns, and the backing trapping at least a part of the synthetic fibre in the backing.

The present invention relates to pile weather stripping and methods of making the same. The invention also includes machinery for forming such weather stripping, and a method for making such weather stripping.

### TECHNICAL BACKGROUND

Pile weather stripping has been, and still is applied around windows, screens and doors. Typically such stripping is manufactured in large quantities in continuous lengths for this purpose. The typical standard for weather stripping is a flat backing with a woven pile material extending from the backing. This weather stripping is typically inserted into a T-shaped slot around the window, screen or door.

### SUMMARY OF THE INVENTION

An object of the present invention is to provide an improved pile weather strip seal and method of making the same. An advantage of the pile weather strip according to the present invention is that it can be recyclable. An advantage of the present invention is that the method can be more economic and efficient at higher speeds. A further advantage of the method is that it can allow for wider variations of backing profiles, pile heights and better quality.

The present invention includes a method of forming a weather stripping, comprising:

guiding one or more strips of pile into an extruder, and
forming a backing on the pile by extrusion.

The method can be used to make a weather stripping comprising pile extending from a backing, the pile comprising pile yarns, the extruded backing being bonded to the pile. A synthetic fibre can be interlaced with the pile yarns, and the backing then traps at least a part of the synthetic fibre in the backing.

In one aspect a pile weather stripping according to the present invention uses a pile having first fibres and second fibres and an elongate backing, e.g. a polymeric or resin backing that is formed, e.g. extruded around the pile and including the second fibres. The backing will typically be made of PVC or a replacement therefor.

Embodiments of the present invention can be used, for example, in windows, such as PVC windows so that the combination of pile weather stripping and PVC window extrusion sections can be recycled without subsequently separating them. The weather stripping may also be used in doors or insect screens. The product is made using a first fibre or thread such as a polymeric fibre or thread which is used as a pile. Second fibres are located around or interlaced, interwoven, etc. e.g. by weaving or knitting, with first pile fibres, e.g. pile threads or yarns. The second fibres extend in a direction substantially perpendicular to the longitudinal direction of the pile yarns. A polymeric backing is provided such as a PVC backing which encapsulates at least a part of the second fibre or thread and bonds thereto. The backing may be an extruded profile, e.g. having a cross-section that may clip into or slide into a recess in a window frame, door or screen. Preferably the backing is extruded over an end of the pile yarns to thereby encapsulate at least a part of the second fibre or thread while leaving the other end of the pile threads or yarns free.

The backing or base can be a foamed resin. The backing may be a thermoplastic polymer or a thermoplastic elastomer. If required the backing can be cross-linked. Any suitable pile can be used, e.g. woven, non-woven such as knitted or wound. The backing can be shaped for insertion into a retaining slot, e.g. a T-shaped slot, especially for windows and doors. Even lengths of filaments, e.g. woven or non-woven filaments such as knitted or wound filaments are secured along the sides of the backing and/or in the backing itself by allowing a polymer or resin to surround the pile. The present invention has the advantage of giving exceptional adhesion between the pile and the backing. The adding or removing of filling yarns, picks and changing of the yarn denier determines the insulating quality of the weather stripping. One or more fins can be added by inserting the one or more fins into the pile or the one or more fins can be extruded as part of the process to give additional insulating abilities. The fins may be made of the same material as the backing or may be a different material. The fins may be made of a polymer or resin, e.g. preferably PVC but if the backing is made of a polyolefin then the fin can be made of the same material, e.g. such as polypropylene or a mixture of polypropylene and polyethylene.

A further advantage of the method of making the pile weather stripping according to the present invention is that it allows flexibility in fabrication parameters, e.g. varying the pile height, the pile density and backing configuration to include throat width, slot width e.g. T-slot width, slot backing depth, e.g. T-slot backing depth and varying fin heights.

The present invention also includes machinery for forming such weather stripping, as well as a method for making such weather stripping.

The pile can be made of polymeric yarns or threads, e.g. a polyolefin pile yarn such polypropylene pile yarns or any other synthetic fibre. Combinations of yarns may be used, e.g. a polyolefin pile yarn such polypropylene pile yarns or any other synthetic fibre combined with PVC warp- or PVC coated warp/backing yarns in a knitting or weaving process. The yarns may be made from different polymeric material than the backing. It is advantageous to coat the pile yarns with a layer of a material which bonds to the backing material, or to coat with the same material as the backing material.

In accordance with embodiments of the invention methods and products are provided which allow a pile yarn material to be used which does not bond easily with a polymer used for the backing. For example, polypropylene yarn will not easily bond to the material of the backing, e.g. to a PVC extrusion. In an aspect of the present invention PVC coated warp yarns are mechanically connected to a PVC backing. These PVC coated warp yarns are located around or are interlaced or interwoven with the pile yarns, e.g. they are knitted or woven into pile yarns, e.g. polypropylene or other synthetic yarns. This combination is then bonded to a polymeric backing such as a PVC extrusion thereby effecting a bond between the polypropylene or other synthetic yarn and the polymeric backing, e.g. PVC extrusion.

Ends of the yarns may be singed, pre-coated or a combined process may be used of singing and pre-coating to secure the pile yarns together and to improve the bonding of the knitted or woven interlaced first fibre, e.g. PVC yarn with the backing, e.g. with the extruded profile.

The polymer materials used for the backing, e.g. PVC resins, preferably provide the necessary stiffness and rigidity to be able to insert the finished profile into a frame such as a door or window frame both inline during the PVC window/door profile extrusion or off line in PVC extruded profiles. This avoids the use of metal reinforcing materials which may make recycling difficult.

The singing process runs normally at 470° F. and the extrusion—coating process at 320-350° F. Those temperatures however are only indicative and may vary depending on the yarns and resins used.

Product according to embodiments of the present invention can be used in PVC extrusions so that the scrap can be recycled, e.g. reuse of the total product recuperated without removing the pile weather strip first.

### BRIEF DESCRIPTION OF THE DRAWINGS

FIG. 1 is a drawing of the weather stripping showing the knitted pile with an extruded backing in accordance with an embodiment of the present invention.

FIG. 2 is a drawing of the weather stripping showing the knitted pile separate from the backing.

FIG. 3 is a drawing of the weather stripping showing the knitted pile allowed to bloom in accordance with an embodiment of the present invention.

FIG. 4 is a drawing of the weather stripping showing the knitted pile with an extruded backing in accordance with an embodiment of the present invention.

FIG. 5 is a drawing of the weather stripping showing the knitted pile with a center fin in accordance with an embodiment of the present invention.

FIG. 6 is a drawing of the weather stripping showing the knitted pile with an outside fin in accordance with an embodiment of the present invention.

FIG. 7 is a drawing of the weather stripping showing the knitted pile with two outside fins and a center fin in accordance with an embodiment of the present invention.

FIG. 8 is a drawing of the weather stripping showing an extruded scored backing to act as a living hinge in accordance with an embodiment of the present invention.

FIG. 9 is a drawing of the weather stripping showing an extruded V-backing in accordance with an embodiment of the present invention.

FIG. 10 is a schematic cross-section of a weather stripping in accordance with the present invention.

FIG. 11 is a schematic representation of machinery for a process according to an embodiment of the present invention in accordance with an embodiment of the present invention.

### DETAILED DESCRIPTION

The present invention will be described with reference to certain drawings and to certain embodiments but this description is by way of example only. The weather stripping according to the present invention may be for use in a retaining slot, e.g. a T-slot into which the weather stripping is inserted with an interference fit.

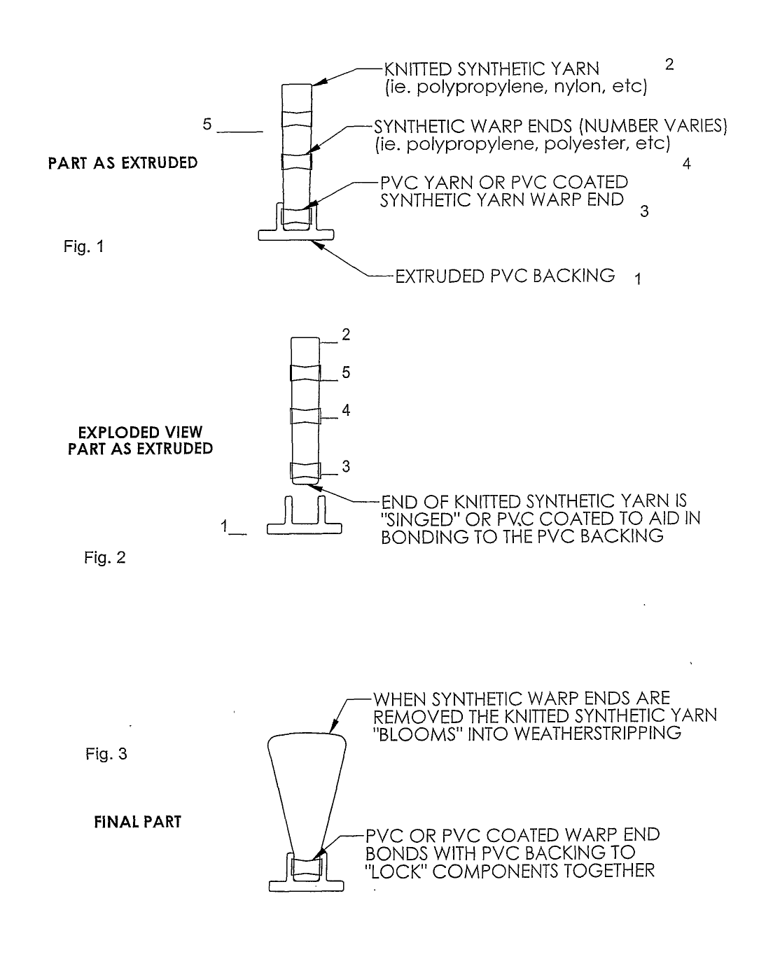

FIG. 1 shows an embodiment of the present invention. It comprises a backing 1 which encapsulates the ends of pile yarns 2. The pile yarns 2 can be woven or non-woven pile yarns such as knitted yarns. The pile yarns are held together or supported by at least one synthetic yarn 3. The synthetic yarn 3 can be located around or interlaced or interwoven into the pile yarns 2, e.g. by knitting or weaving. Whereas the pile yarns are shown extending substantially vertically on the page, the synthetic yarns extend substantially perpendicular to this direction.

The synthetic yarn 3 is preferably coated with or comprises a polymer material which bonds well to the polymeric material of backing 1. For example, when the backing is PVC, then the synthetic yarn 3 can be PVC yarn or PVC coated synthetic yarn.

One or more additional or optional synthetic warp ends 4, 5 may be used to restrain or control the pile threads, e.g. they may laid around or be woven or knitted into the pile yarns 2. These additional or optional threads can be made of any suitable material, e.g. textile, synthetic or natural threads.

FIG. 2 shows the secured pile yarns 2 before being fixed or bonded to the backing 1.

After the fixing of the backing 1 to the pile yarns 2 in such a way as to trap the ends of the pile yarns 2 and at least some of the synthetic yarns 3 and to bond the backing to these, some or all of the additional restraining yarns 4, 5 may be removed or cut away as shown in FIG. 3.

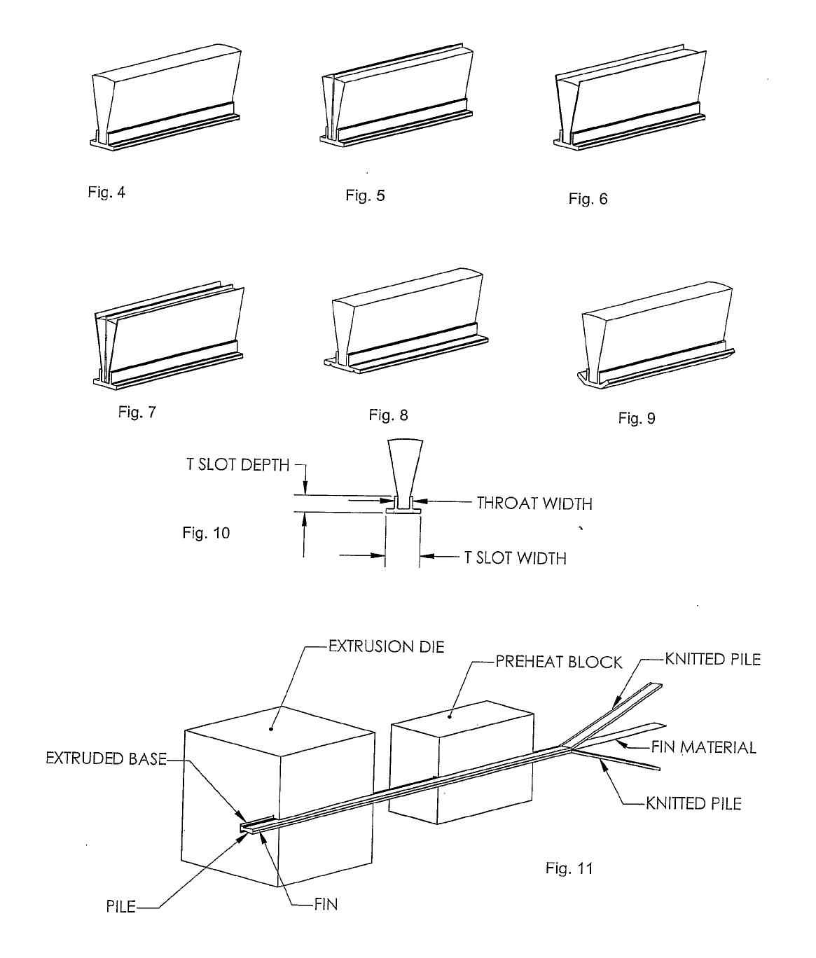

FIGS. 4 to 10 show various designs of weather stripping which can be used with the present invention. The weather stripping comprises an elongate backing and pile threads or filaments extending therefrom at any suitable angle. The pile threads have further fibres which are interlaced with the pile threads. The interlaced fibres are at least partly trapped in the backing in the final product. The interlaced fibres preferably bond well to the backing in the final product

In accordance with an embodiment of the present invention extruding a continuous length of polymer or resin forms a profiled backing of the weather stripping as shown in all of FIGS. 4 to 10. The polymer or resin is allowed to flow in a plastic or molten state around the pile with the interlaced fibres giving exceptional bonding between the pile and backing. To achieve this the pile is fed into a suitable extruder. A preferred resin or polymer is PVC. Less preferred is a polyolefin resin, e.g. polypropylene or a blend of polypropylene and polyethylene. The backing may be of a foamed material. The backing may be cross-linked.

In an alternative method and to further enhance the bonding between the backing and the pile, the pile is introduced using guides to a singing bar that heats and pre-melts the pile directly before it is introduced to the extrusion die where the resin is allowed to flow around the pile as illustrated in FIG. 11. The pre-melting is done on the ends of the filaments on one side of the pile strip.

Before forming into a strip of pile for entry into the die, the pile is formed woven or non-woven, e.g. knitted and then slit or cropped to the correct pile height or may be wound as described in U.S. Pat. No. 4,024,004 which is incorporated herein by reference. The pile may be formed of monofilaments or multifilaments, e.g. threads or yarns, of any suitable material, preferably thermoplastic material, e.g. polymeric filaments. By adjusting the density of the pile by adding or subtracting picks, filling yarns and changing of the yarn denier determines the insulating quality of the weather stripping.

In accordance with an embodiment of the present invention one or more fins, e.g. made of a polymeric material such as a polyolefin, e.g. polypropylene or a blend of polypropylene and polyethylene, can be included within the pile. A fin can further enhance the insulating quality of the weather stripping. A fin maybe located within the pile and/or at the side of the pile. The fin or fins extend in the same direction as the filaments of the pile from the backing. The fin or fins can be the same length as the pile, i.e. is coterminous with the filaments or maybe be a different length. In one embodiment when N fins are to be added to the weather stripping, where N is one or more, the strand of pile is divided into N, N−1 or N+1 strips and these separate strips of pile are run simultaneously into the extrusion die where the fin or fins can be co-extruded along with the backing. The N, N−1, or N+1 strips of pile can be optionally sent through a singing bar before entry into the extruder. In an alternative embodiment the fin or fins can be added to the N, N−1 or N+1 pile strips as a secondary operation and then the combination fed to the extruder die. The fins or fin can be added into the pile by ploughing. Optionally, before the strips of pile enter the die the N fins can be attached to the pile, e.g. by a mechanical or thermal process such as ultrasonically welding or laser welding the fin or fins into place.

Machinery for making the weather stripping is shown schematically in FIG. 11. Sources of one or more pile strips are provided, e.g. reels or drums and the one or more strips are lead towards an extruder die for co-extrusion with polymer from the extruder. Optionally a singer may be provided for singing the pile before it enters the extruder die.

In an alternative embodiment of the present invention one or more pile strips are fed towards a joining device and one or more fins are inserted into the pile. The combination is temporarily bonded in the joining device before the combination is fed to the extruder die. The joining device can be a mechanical or thermal joining device, e.g. an ultrasonic welder or laser welder.

The inventive weather stripping allows for the creation of different backing configurations as shown in FIGS. 1, 3, 8 and 9. The creation of these different backings is based on the profile that is cut into the extrusion die itself along with melt temperatures and material draw downs used in the extruder. The inventive pile weather stripping allows for the fabrication of any pile height, pile density and backing configuration to include throat width, T-slot width, T-slot backing depth and varying fin heights (see FIG. 10).

1. A method of forming a weather stripping, comprising:
guiding one or more strips of pile into an extruder, and
forming a backing on the pile by extrusion.

2. The method of claim 1 comprising:
interlacing a synthetic fibre with the one or more strips of pile, and
forming the backing on the pile to thereby trap at least a part of the synthetic fibre in the backing.

3. The method of claim 1, further comprising singing the pile before it is fed into the extruder.

4. The method of claim 2, wherein the pile yarns do not bond well to the backing and the synthetic fibre includes a material which bonds well to the backing.

5. The method of any of claim 2, wherein the synthetic fibre includes a PVC material.

6. The method of claim 1, wherein the backing includes a PVC material.

7. The method of claim 1, further comprising the step of forming at least one fin in the pile of the weather stripping.

8. The method according to claim 7, further comprising joining the at least one fin to the one or more pile strips before forming the backing by extrusion.

9. The method of claim 8, wherein the joining is by ultrasonic welding or laser welding.

10. The method according to claim 7, further comprising forming the at least one fin by extrusion at the same time as the backing.

11. A weather stripping comprising pile extending from a backing, the pile comprising pile yarns, the backing being bonded to the pile, a synthetic fibre being interlaced with the pile yarns, and the backing trapping at least a part of the synthetic fibre in the backing.

12. The weather stripping of claim 12 the backing being bonded to the pile by extrusion.

13. The weather stripping of claim 12, wherein the synthetic fibre includes a PVC material.

14. The weather stripping of claim 12, further comprising at least one fin in the pile of the weather stripping.

15. The weather stripping of claim 12, wherein the synthetic fibre is coated with PVC.

16. The weather stripping of claim 12, wherein the backing includes a PVC material.

17. Machinery for forming a weather stripping, comprising:
means for guiding one or more strips of pile into an extruder, and
means for forming a backing on the pile by extrusion.

18. The machinery of claim 17, further comprising means for at least one fin in the pile of the weather stripping.

19. The machinery of claim 17, further comprising means for singing the pile before it is fed into the extruder.

20. The machinery according to claim 18, further comprising means for joining the at least one fin to the one or more pile strips before forming the backing by extrusion.

21. The machinery of claim 20, wherein the means for joining is an ultrasonic welder or a laser welder.
